(19) United States
(12) Patent Application Publication
(10) Pub. No.: US 2026/0050609 A1
(43) Pub. Date: Feb. 19, 2026

(54) DATABASE PROCESSING METHOD, DEVICE AND STORAGE MEDIUM

(71) Applicant: Beijing Volcano Engine Technology Co., Ltd., Beijing (CN)

(72) Inventors: Liya FAN, Beijing (CN); Jianhua CAO, Beijing (CN); Dongyan ZHOU, Beijing (CN); Dongwei WANG, Beijing (CN); Heng CHEN, Beijing (CN); Rui SHI, Beijing (CN)

(21) Appl. No.: 19/270,394

(22) Filed: Jul. 15, 2025

(30) Foreign Application Priority Data
Aug. 19, 2024 (CN) 202411141095.9

(51) Int. Cl. G06F 16/28

(52) U.S. Cl. CPC G06F 16/284

(57) ABSTRACT

Embodiments of the present disclosure provide a database processing method and device and a storage medium. The method includes: receiving an operation instruction for a database, and determining whether dictionary-based optimization is enabled for a target column associated with the operation instruction; in response to determining that the dictionary-based optimization is enabled, obtaining a dictionary corresponding to the target column, wherein the dictionary includes a mapping relationship between a value included in the target column and a corresponding replacement value; encoding the target column based on the dictionary to replace the value included in the target column with the corresponding replacement value; and converting, based on the dictionary, the operation instruction into an operation instruction corresponding to the encoded target column, executing the converted operation instruction, and decoding an operation result based on the dictionary.

### CROSS-REFERENCE TO RELATED APPLICATION(S)

This application claims priority to Chinese Application No. 202411141095.9 filed Aug. 19, 2024, the disclosure of which is incorporated herein by reference in its entirety.

### TECHNICAL FIELD

Embodiments of the present disclosure relate to the field of computer and network communication technologies, and in particular, to a database processing method and device and a storage medium.

### BACKGROUND

In a process of performing a query or scan on a database, query performance may be optimized by dictionary encoding/decoding. For example, a type of a data column is a character string (such as varchar(30)), and it is known that the column may only have three possible values, i.e., “aaa”, “bbb”, and “ccc”. Then, in a start stage of query processing, dictionary encoding may be performed on the column, for example, the integer 0 is used to replace “aaa”, 1 is used to replace “bbb”, and 2 is used to replace “ccc”. Correspondingly, a query instruction is replaced in the query processing. In a final stage of the query processing, a query result may be decoded, 0 is replaced with “aaa”, 1 is replaced with “bbb”, and 2 is replaced with “ccc”, so that a same result as an original query is obtained. The entire query process is implemented based on a replacement value, which can optimize the query performance.

In the prior art, the use of a dictionary in a database processing process is controlled by a user, which causes additional resource overhead, resulting in an increase in user maintenance costs, and may lead to a decline in database query performance.

### SUMMARY

Embodiments of the present disclosure provide a database processing method and device and a storage medium.

According to a first aspect, an embodiment of the present disclosure provides a database processing method, including:
receiving an operation instruction for a database, and determining whether dictionary-based optimization is enabled for a target column associated with the operation instruction;
in response to determining that the dictionary-based optimization is enabled, obtaining a dictionary corresponding to the target column, wherein the dictionary includes a mapping relationship between a value included in the target column and a corresponding replacement value;
encoding the target column based on the dictionary to replace the value included in the target column with the corresponding replacement value; and
converting, based on the dictionary, the operation instruction into an operation instruction corresponding to the encoded target column, executing the converted operation instruction, and decoding an operation result based on the dictionary.

According to a second aspect, an embodiment of the present disclosure provides a database processing apparatus, including:
a decision unit, configured to receive an operation instruction for a database, and determine whether dictionary-based optimization is enabled for a target column associated with the operation instruction;
a dictionary obtaining unit, configured to: in response to determining that the dictionary-based optimization is enabled, obtain a dictionary corresponding to the target column, wherein the dictionary includes a mapping relationship between a value included in the target column and a corresponding replacement value;
an encoding unit, configured to encode the target column based on the dictionary to replace the value included in the target column with the corresponding replacement value; and
an execution unit, configured to: convert, based on the dictionary, the operation instruction into an operation instruction corresponding to the encoded target column, execute the converted operation instruction, and decode an operation result based on the dictionary.

According to a third aspect, an embodiment of the present disclosure provides an electronic device, including: at least one processor and a memory;
wherein the memory stores computer-executed instructions; and
the at least one processor executes the computer-executed instructions stored in the memory, to cause the at least one processor to execute the database processing method according to the first aspect and various possible designs of the first aspect.

According to a fourth aspect, an embodiment of the present disclosure provides a computer-readable storage medium storing computer-executed instructions therein, and when the computer-executed instructions are executed by a processor, the database processing method according to the first aspect and various possible designs of the first aspect is implemented.

According to a fifth aspect, an embodiment of the present disclosure provides a computer program product including a computer-executed instructions, and when the computer-executed instructions are executed by a processor, the database processing method according to the first aspect and various possible designs of the first aspect is implemented.

In the database processing method and device and the storage medium provided in the embodiments of the present disclosure, an operation instruction for a database is received, and whether dictionary-based optimization is enabled for a target column associated with the operation instruction is determined. In response to determining that the dictionary-based optimization is enabled, a dictionary corresponding to the target column is obtained. The target column is encoded based on the dictionary to replace a value included in the target column with a corresponding replacement value. Finally, the operation instruction is converted into an operation instruction corresponding to the encoded target column based on the dictionary, the converted operation instruction is executed, and an operation result is decoded based on the dictionary. In the embodiments of the present disclosure, whether dictionary-based optimization is enabled is automatically determined during a database operation, and then the dictionary is obtained, so that the user maintenance costs are reduced, and the database operation performance is improved.

### BRIEF DESCRIPTION OF THE DRAWINGS

In order to illustrate the technical solutions in the embodiments of the present disclosure or in the prior art more clearly, the following briefly introduces the drawings required for describing the embodiments or the prior art. Apparently, the drawings in the following description show some embodiments of the present disclosure, and persons of ordinary skill in the art may still derive other drawings from these drawings without creative efforts.

FIG. 1 is a schematic diagram of a scenario of a database processing method according to an embodiment of the present disclosure;

FIG. 2 is a schematic flowchart of a database processing method according to an embodiment of the present disclosure;

FIG. 3 is a schematic flowchart of dictionary maintenance according to an embodiment of the present disclosure;

FIG. 4 is a schematic flowchart of a database processing method according to another embodiment of the present disclosure;

FIG. 5 is a block diagram of a structure of a database processing apparatus according to an embodiment of the present disclosure; and

FIG. 6 is a schematic diagram of a hardware structure of an electronic device according to an embodiment of the present disclosure.

### DETAILED DESCRIPTION OF EMBODIMENTS

In order to make the objectives, technical solutions, and advantages of the embodiments of the present disclosure clearer, the following clearly and comprehensively describes the technical solutions in the embodiments of the present disclosure with reference to the drawings in the embodiments of the present disclosure. Apparently, the described embodiments are merely some rather than all of the embodiments of the present disclosure. All other embodiments obtained by persons of ordinary skill in the art based on the embodiments of the present disclosure without creative efforts shall fall within the protection scope of the present disclosure.

It should be noted that user information (including but not limited to user device information, user personal information, and the like) and data (including but not limited to data for analysis, data for storage, data for display, and the like) involved in this application are information and data authorized by a user or fully authorized by parties. Moreover, the collection, use, and processing of related data need to comply with relevant laws, regulations, and standards of relevant countries and regions, and a corresponding operation entry is provided for the user to select authorization or rejection.

In order to clearly understand the technical solutions of this application, the solutions of the prior art are first introduced in detail.

In a process of performing a query or scan on a database, query performance may be optimized by dictionary encoding/decoding. For example, a type of a data column is a character string (such as varchar(30)), and it is known that the column may only have three possible values, i.e., “aaa”, “bbb”, and “ccc”. Then, in a start stage of query processing, dictionary encoding may be performed on the column. For example, the integer 0 is used to replace “aaa”, 1 is used to replace “bbb”, and 2 is used to replace “ccc”. Correspondingly, a query instruction is replaced in the query processing. In a final stage of the query processing, a query result may be decoded, 0 is replaced with “aaa”, 1 is replaced with “bbb”, and 2 is replaced with “ccc”, so that a same result as an original query is obtained. The entire query process is implemented based on a replacement value, which can optimize the query performance.

After the dictionary encoding optimization, the execution efficiency of a query is significantly improved, because:
1. The data amount of the query processing is significantly reduced. For example, in the above example, after int64 is used to replace varchar(30), the data amount of the column can be reduced by more than three times at most.
2. For most database execution engines, the efficiency of processing integer and fixed-length data types is much higher than the efficiency of processing variable-length data types.

Because the dictionary encoding is very helpful for the performance improvement of the database query, this technology has been widely used in a plurality of database products to help improve the query performance.

However, the current dictionary optimization technology has the following problems:
1. The content of a dictionary needs to be provided by a user, but cannot be automatically deduced by a database system.
2. When data in a database changes, the content of a dictionary needs to be updated. The existing dictionary updating solutions are as follows, but all have some problems:
a. A user needs to manually update the content of a dictionary, so that the automation is not enough;
b. A dictionary updating period may be configured to periodically update the content of a dictionary, but a dictionary obtained in this manner may not be the latest; and
c. The content of a dictionary may be dynamically obtained in real time in a query using the dictionary, but this manner may have a performance overhead, especially when there is no change in data, there is no need to re-generate the dictionary.
3. After the dictionary encoding optimization is introduced, the query performance would be not necessarily improved. For example, if a dictionary is too large, the overhead of encoding and decoding also increases, which may lead to a decline in query performance. For example, if a database has 100 rows, and a data column has 100 different values, the dictionary needs to include 100 entries, which may not significantly improve the query performance, but the encoding and decoding process requires a large amount of performance overhead. The existing system cannot distinguish between these cases, and the dictionary optimization technology is used indiscriminately.
4. The existing technology can only perform dictionary encoding on columns in a database table, but cannot perform encoding on intermediate results of a query, for example, intermediate results of operations such as a join operation and a project operation, so that some queries cannot use the dictionary encoding optimization.

In order to solve at least one of the above technical problems, an embodiment of the present disclosure provides a database processing method. Whether dictionary-based optimization needs to be enabled for a target column associated with an operation instruction may be automatically determined based on the operation instruction for a database. If the dictionary-based optimization needs to be enabled, a dictionary corresponding to the target column is obtained, so that user maintenance costs are reduced, and a query performance decline is prevented.

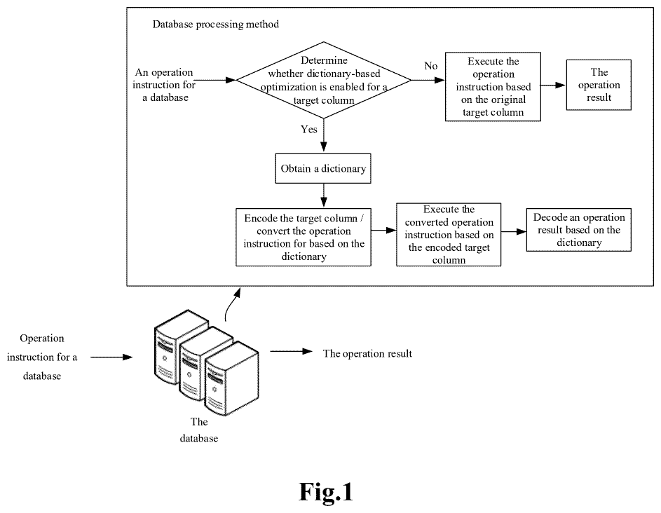

The database processing method provided in the embodiment of the present disclosure may be applied to an application scenario as shown in FIG. 1. An operation instruction for a database is received, and whether dictionary-based optimization is enabled for a target column associated with the operation instruction is determined. In response to determining that the dictionary-based optimization is enabled, a dictionary corresponding to the target column is obtained. The target column is encoded based on the dictionary to replace a value included in the target column with a corresponding replacement value. Finally, the operation instruction is converted into an operation instruction corresponding to the encoded target column based on the dictionary, the converted operation instruction is executed, and an operation result is decoded based on the dictionary.

The database processing method of the present disclosure is described in detail below with reference to specific embodiments.

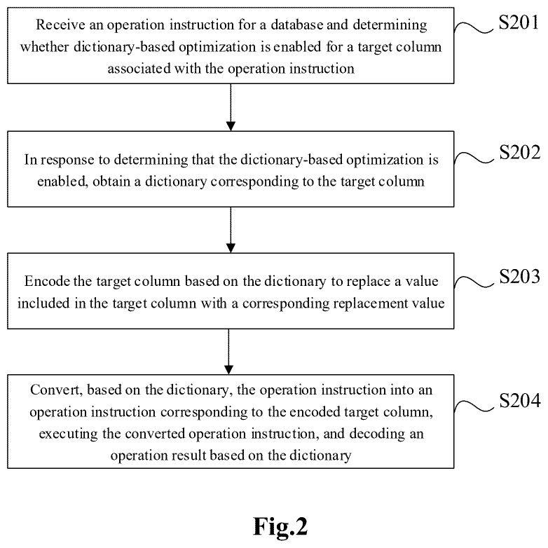

Referring to FIG. 2, FIG. 2 is a schematic flowchart of a database processing method according to an embodiment of the present disclosure. The method in this embodiment may be applied to an electronic device such as a server. The database processing method includes the following steps.

S201, an operation instruction for a database is received, and whether dictionary-based optimization is enabled for a target column associated with the operation instruction is determined.

In this embodiment, in order to improve query performance and avoid a reduction in query performance after a dictionary is used, after receiving an operation instruction for a database from a user, it is necessary to first measure the query performance of a target column corresponding to the operation instruction after the dictionary is used, and determine, based on a measurement result, whether it is necessary to enable dictionary-based optimization. Then, the dictionary is obtained on the premise of the dictionary-based optimization, so as to avoid blindly using the dictionary to reduce the query performance.

The operation instruction may include, but is not limited to, a query operation (or filtering operation, filter) based on the target column, a scan operation (scan), a join operation (join), a project operation (project), and the like in the database.

S202, in response to determining that the dictionary-based optimization is enabled, a dictionary corresponding to the target column is obtained.

In this embodiment, the dictionary includes a mapping relationship between a value included in the target column and a corresponding replacement value. The replacement value may refer to a value obtained by replacing the value in the target column. Optionally, the replacement value may have a shorter length than the value in the target column, and/or a data type of the replacement value is different from a data type of the value in the target column.

In this embodiment, in response to determining that the dictionary-based optimization is enabled, the electronic device may obtain the dictionary corresponding to the target column, so as to encode data of the target column based on the dictionary.

In a possible implementation, the dictionary corresponding to the target column is obtained in the following two manners.

A number of distinct values included in the target column of the database is obtained. In response to the number of distinct values being less than a preset number threshold, the distinct values included in the target column are obtained, and the dictionary is constructed based on the distinct values included in the target column; and/or

Distinct values included in the target column are obtained based on an operator and/or a function included in a first execution plan corresponding to the operation instruction, and the dictionary is constructed based on some or all of the distinct values.

In this embodiment, in the first manner of obtaining the dictionary, the electronic device may obtain the number of distinct values (Number of Distinct Values, NDV) included in the target column. This indicator is an important indicator in the database statistics, and is used to describe the number of distinct values included in the target column. For example, if the target column may only have three possible values, i.e., “aaa”, “bbb”, and “ccc”, the NDV of the target column is 3. Optionally, the number of distinct values included in the target column may be obtained by querying an SQL query instruction, or may be obtained from statistics (such as meta metadata information) maintained by a database system, or may be obtained by using any other feasible method. This is not limited here.

Further, the number of distinct values included in the target column may be compared with a preset number threshold. In response to the number of distinct values being less than the preset number threshold, it indicates that the number of distinct values in the target column is sufficiently small, and the performance overhead of encoding and decoding for generating the dictionary is not great. Therefore, the distinct values included in the target column may be obtained, and the dictionary is constructed based on the distinct values. The dictionary is automatically generated through the statistics, without the need for a user to provide the content of the dictionary, thereby reducing the user costs.

Optionally, in response to the NDV being less than the preset data threshold, an execution plan for querying the distinct values included in the target column may be sent to an execution engine of the database. For the convenience of description, the execution plan is referred to as a second execution plan here. Then, the execution engine executes the second execution plan to implement the query of the distinct values included in the target column, and receives the distinct values included in the target column returned by the execution engine. As an example, an SQL query instruction corresponding to the second execution plan may be: select distinct x from tbl where x is not null; wherein x refers to a value in the target column, and tbl refers to the target column. Certainly, in this embodiment, other feasible methods may also be used to obtain the distinct values included in the target column, for example, directly sending an SQL execution instruction instead of an execution plan, and so on. This is not described in detail here.

Further, when the dictionary is constructed based on the distinct values included in the target column, a value included in the target column is actually mapped to a replacement value, i.e., a mapping relationship between the distinct values included in the target column and the replacement values corresponding to the distinct values is established. Optionally, the distinct values included in the target column may be sorted, and each value corresponds to one replacement value, and the replacement values are different from each other. For example, the distinct values are (aaa, bbb, ccc), and the mapping relationship established in the dictionary is {0: aaa, 1: bbb, 2: ccc}, i.e., 0 is used to replace “aaa”, 1 is used to replace “bbb”, and 2 is used to replace “ccc”. In the second manner of obtaining the dictionary, some or all of the distinct values included in the target column may be obtained based on the operator and/or the function included in the first execution plan corresponding to the operation instruction, and the dictionary is constructed based on some or all of the distinct values. The dictionary is automatically generated through theoretical derivation, without the need for a user to provide the content of the dictionary, thereby reducing the user costs.

The first execution plan may refer to a detailed instruction sequence generated by an optimizer when the database executes the operation instruction.

The operator may refer to an identification for operating on a value of the target column, including but not limited to a scan operator (scan), a filter operator (filter), a join operator (join), a project operator (project), and the like.

The scan operator (scan) is used to traverse values of the target column;
the filter operator (filter) is used to filter, screen, and modify values in the target column, to ensure that only records that meet a specific condition are selected or displayed;
the join operator (join) is used to connect two or more tables; and
the project operator (project) may be used to extract specified information of the target column.

The function may include substr, concat, reverse, trim, ltrim, rtrim, lower, upper, left, right, replace, replicate, and the like in the database.

According to the operator and/or the function

In a possible implementation, for the dictionary obtaining manners provided in the above embodiment, different dictionary obtaining manners may be used in different cases. Specifically, the dictionary corresponding to the target column is obtained as follows:

The first execution plan is generated based on the operation instruction, and the operator type included in the first execution plan is determined;

In response to determining that the operator type includes a scan operator, the number of distinct values included in the target column of the database is obtained. In response to the number of distinct values being less than the preset number threshold, the distinct values included in the target column are obtained, and the first dictionary is constructed based on the distinct values included in the target column; and/or

In response to determining that the operator type includes a filter operator or a join operator, the distinct values included in the target column are obtained based on a predicate in the operator, and the second dictionary is constructed based on the distinct values included in the target column; and/or

In response to determining that the operator type includes a project operator, the distinct values included in the target column are obtained based on the function in the operator, and the third dictionary is constructed based on the distinct values included in the target column.

In this embodiment, because the performance overheads of the different dictionary obtaining manners are different, and the sizes of the dictionary may be different, the dictionary obtaining manner may be selected based on an actual requirement. Specifically, after the optimizer of the database generates the first execution plan based on the operation instruction, the dictionary obtaining manner may be determined based on different operator types included in the first execution plan. For example, in different cases where the operator types are a scan operator, a filter operator, a join operator, and/or a project operator, different dictionary obtaining manners may be used.

Specifically, if the operator type is a scan operator and the number of distinct values is less than the preset number threshold, it is necessary to construct a dictionary based on all distinct values included in the target column. By obtaining all distinct values included in the target column, the most complete dictionary may be constructed, which is referred to as a first dictionary here, and the encoding and decoding of all values of the target column may be implemented.

If the operator type includes a filter operator or a join operator, some or all of the distinct values included in the target column may be involved, which may be specifically reflected in a predicate of the operator. In the operator, the predicate may be used to describe a condition or constraint of data. Therefore, some or all of the distinct values included in the target column may be obtained based on the predicate in the operator, and the second dictionary is constructed based on some or all of the distinct values.

Exemplarily, if the operator type in the first execution plan includes a filter operator or a join operator, all predicates of the operator are extracted. If the predicate is an in-predicate, which is used to check whether a value of the target column is in a specific set, for example, a predicate of the filter operator is x in (‘a’, ‘b’, ‘c’), i.e., data whose value in the target column x is in the set (‘a’, ‘b’, ‘c’) is filtered, it may be described that only three values ‘a’, ‘b’, and ‘c’ are focused on for the target column, and a dictionary {0: a, 1: b, 2: c} may be constructed. If the predicate is a disjunctive normal form (i.e., a logical expression, which is used to simplify and optimize a query condition) and there are the same variables, such as x=‘a’ or x=‘b’ or x=‘c’, it also means that only three values ‘a’, ‘b’, and ‘c’ are focused on for the target column, and a dictionary {0: a, 1: b, 2: c} may be constructed for the target column x.

If the operator type in the first execution plan includes a project operator, all function calls in the operator are extracted, for example, a function substr (x, 1, 2), wherein the target column x is a character string column. The function represents a subsequence of the target column x that starts from the subscript 1 and has a length of 2. Assuming that it is known that values in the target column x include {‘aaa’, ‘bbb’, ‘ccc’}, it may be deduced that values of the subsequence constructed based on the function substr (x, 1, 2) include {‘aa’, ‘bb’, ‘cc’}. Therefore, the dictionary {0: aa, 1: bb, 2: cc} corresponding to the subsequence may be constructed. Certainly, the function may further include, but is not limited to, concat, reverse, trim, ltrim, rtrim, lower, upper, left, right, replace, replicate, and the like in the database. The usage of each function is not described in detail here.

S203, the target column is encoded based on the dictionary to replace the value included in the target column with the corresponding replacement value.

In this embodiment, the target column is encoded based on the dictionary, i.e., the value included in the target column is replaced with the corresponding replacement value based on the dictionary. The specific encoding process is not described in detail here.

In S204, the operation instruction is converted into an operation instruction corresponding to the encoded target column based on the dictionary, the converted operation instruction is executed, and an operation result is decoded based on the dictionary.

In this embodiment, the operation instruction is converted into the operation instruction corresponding to the encoded target column based on the dictionary, i.e., if the operation instruction involves a specific value of the target column, the specific value is replaced with the corresponding replacement value based on the dictionary. If the operation instruction does not involve a specific value of the target column, for example, a join operation instruction, it may be specified, through conversion, that the join operation is performed on the encoded target column, instead of the original target column. Further, the converted operation instruction may be executed to obtain the operation result, and then the replacement value in the operation result is replaced with the original value of the target column based on the dictionary, so that the encoding and decoding of the target column are implemented, and the query performance is improved.

In the database processing method provided in this embodiment, an operation instruction for a database is received, and whether dictionary-based optimization is enabled for a target column associated with the operation instruction is determined. In response to determining that the dictionary-based optimization is enabled, a dictionary corresponding to the target column is obtained. The target column is encoded based on the dictionary to replace a value included in the target column with a corresponding replacement value. Finally, the operation instruction is converted into an operation instruction corresponding to the encoded target column based on the dictionary, the converted operation instruction is executed, and an operation result is decoded based on the dictionary. In this embodiment, whether dictionary-based optimization is enabled is automatically determined, and then the dictionary is obtained, without the need for user intervention, so that the user maintenance costs are reduced, the database processing performance is improved, the method can be applied to any database operation process, and the dictionary-based optimization of the intermediate result can also be implemented.

In a possible implementation, the dictionary corresponding to the target column is obtained in S202, the dictionary corresponding to the target column may further be obtained as follows:

Whether the dictionary is stored in a cache is determined;

In response to determining that the dictionary is not stored in the cache, the dictionary is created and stored in the cache; or

In response to determining that the dictionary is stored in the cache and the dictionary has not expired, the dictionary is obtained from the cache.

In this embodiment, a dictionary generated through the statistics needs to send an execution plan to the execution engine, and therefore has a certain performance overhead, while a dictionary obtained through theoretical derivation has almost no performance overhead. Therefore, in order to reduce the performance overhead of generating the dictionary according to the statistics, it is necessary to cache the dictionary generated through the statistics in the target column. Optionally, the cache adopts a data structure in a key-value (storing data in key-value pair(s)) format. The key (keyword) includes not only the name of the table and the name of the target column, but also the version number of the table used to generate the dictionary, wherein the table is a table in which the target column is located.

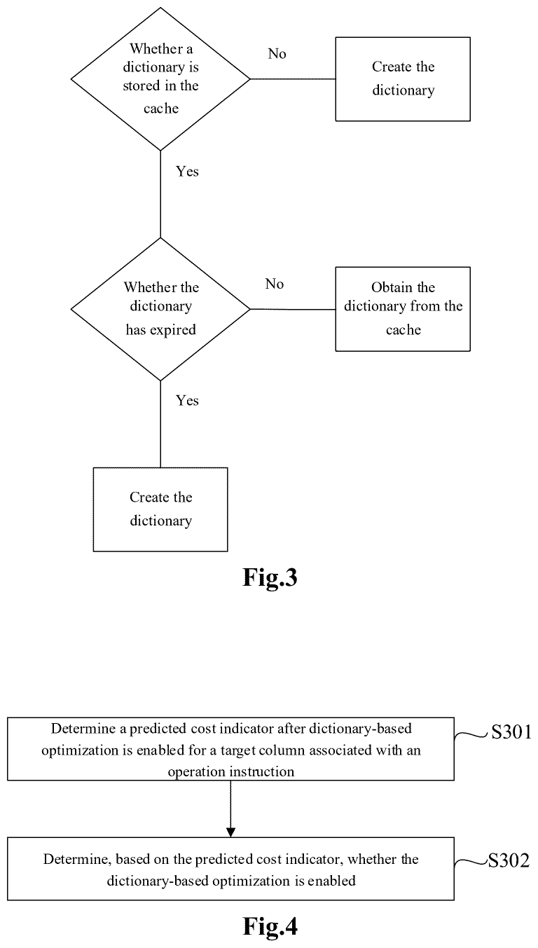

FIG. 3 is a schematic flowchart of dictionary maintenance according to an embodiment of the present disclosure. When an operation instruction is received and a dictionary corresponding to the target column needs to be obtained, whether the corresponding dictionary is stored in the cache may be checked. If the corresponding dictionary is not stored in the cache, the dictionary is created. If the corresponding dictionary is stored in the cache, the data version number of the target column is compared with the data version number for the dictionary in the cache. If the version number comparison result is different, it indicates that the data of the target column has been updated, and the original dictionary has expired and is no longer applicable, and the dictionary needs to be re-created. If the original dictionary has not expired, the dictionary is obtained from the cache. Automatic detection of the dictionary state is implemented, so that the dictionary is regenerated as required, and it is ensured that the dictionary and data used for the query are always matched.

Optionally, in the above embodiment, after the operation instruction is received, whether the number of distinct values in the target column is less than the preset number threshold may be determined first. If the number of distinct values is not less than the preset number threshold, there is no need to check whether the corresponding dictionary is stored in the cache. In response to the number of distinct values being less than the preset number threshold, whether the corresponding dictionary is stored in the cache is checked.

Referring to FIG. 4, FIG. 4 is a schematic flowchart of a database processing method according to another embodiment of the present disclosure. The method in this embodiment may be applied to an electronic device such as a server. Based on the embodiment shown in FIG. 2, the database processing method further includes the following steps.

S301, a predicted cost indicator after the dictionary-based optimization is enabled for the target column associated with the operation instruction is determined.

In this embodiment, because the dictionary encoding optimization does not necessarily bring performance improvement, a cost model is needed to evaluate the overhead and benefit of the execution plan caused by the dictionary optimization.

The cost model should consider the following factors:
1. The greater the number of distinct values (NDV) included in the target column, the greater the cost. This is because the greater the NDV, the larger the dictionary, and the greater the overhead of data encoding and decoding;
2. The smaller the obtained data amount relative to the original data amount after encoding, the greater the performance benefit; and
3. The more complex operations in which the target column participates, the greater the performance benefit. If the data is only encoded first and then decoded finally, only an additional overhead is added without any benefit. The complex operations herein include:
a. A column in a join equi-join condition;
b. One of aggregate columns for an aggregation operation; and
c. Apart of shuffle data.

Based on the above conditions, in order to determine the cost after the dictionary-based optimization is enabled, the predicted cost indicator is used to measure the overhead and benefit after the dictionary-based optimization, so that whether to enable the dictionary-based optimization can be more accurately evaluated.

Specifically, the predicted cost indicator after the dictionary-based optimization is enabled for the target column associated with the operation instruction is determined as follows:

A performance overhead indicator and a performance benefit indicator after the dictionary-based optimization is enabled for the target column associated with the operation instruction are determined, and the predicted cost indicator is determined based on the performance overhead indicator and the performance benefit indicator.

In this embodiment, the predicted cost indicator is determined based on a difference between the performance overhead indicator and the performance benefit indicator. The performance overhead indicator may refer to a resource usage condition after the dictionary-based optimization. The performance benefit indicator may refer to a performance improvement condition after the dictionary-based optimization.

Specifically, the performance overhead indicator after the dictionary-based optimization is enabled for the target column associated with the operation instruction is determined as follows:

A performance overhead indicator generated by encoding the target column based on the dictionary and decoding the operation result is determined.

The performance benefit indicator after the dictionary-based optimization is enabled for the target column associated with the operation instruction is determined as follows:

A first performance benefit indicator generated by a change in data width and/or data type of the value included in the target column after the target column is encoded based on the dictionary is determined; and/or

A second performance benefit indicator generated in the database operation process in which the target column participates after the target column is encoded based on the dictionary is determined.

In this embodiment, the encoding of the target column and the decoding of the operation result generate a performance overhead, and the performance overhead indicator may be determined based on this. After the target column is encoded, changes in the data width and/or data type of the values in the target column may bring a certain benefit, and the first performance benefit indicator may be determined, or the database operation process in which the target column participates may also bring a certain benefit due to the dictionary-based optimization, and the second performance benefit indicator may be determined. The first performance benefit indicator may be zero, and the second performance benefit indicator may also be zero. Therefore, the predicted cost indicator may be determined based on the performance overhead indicator and the first performance benefit indicator, or the predicted cost indicator may be determined based on the performance overhead indicator and the second performance benefit indicator, or the predicted cost indicator may be determined based on the performance overhead indicator, the first performance benefit indicator, and the second performance benefit indicator.

Specifically, the performance overhead indicator generated by encoding the target column based on the dictionary and decoding the operation result is determined as follows:
A first data amount for encoding the target column based on the dictionary and a second data amount decoding the operation result are determined;
A first performance overhead of the encoding process is determined by using a preset encoding complexity function based on the first data amount, and a second performance overhead of the decoding process is determined by using a preset decoding complexity function based on the second data amount;
A sum of the first performance overhead and the second performance overhead is determined as the performance overhead indicator.

In this embodiment, the overhead of the encoding process is related to the first data amount for encoding the target column based on the dictionary, and is also related to the complexity of the encoding process. Therefore, the first performance overhead of the encoding process may be characterized based on the first data amount and the complexity of the encoding process. Optionally, the first performance overhead may be determined by determining a product of the first data amount of the encoding and a value of the preset encoding complexity function. Similarly, the overhead of the decoding process is related to the second data amount decoding the operation result based on the dictionary, and is also related to the complexity of the decoding process. Therefore, the second performance overhead of the decoding process may be characterized based on the second data amount and the complexity of the decoding process. Optionally, the second performance overhead may be determined by determining a product of the second data amount of the decoding and a value of the preset decoding complexity function. The performance overhead indicator is determined based on a sum of the first performance overhead and the second performance overhead.

Exemplarily, assuming that the first data amount involved in the encoding is E, the second data amount involved in the decoding is D, and the size of the dictionary is G, a calculation formula of the performance overhead indicator is as follows:
Performance overhead indicator=E*e(G)+D*d(G)
wherein e( ) and d( ) are functions that describe encoding and decoding complexity, respectively, and the specific functions depend on the encoding and decoding algorithm and data structure used. For example, if a binary search tree is used as the encoding and decoding algorithm, e(G)=c1*log(G). If the data structure is to use an array to store the dictionary, d(G)=c2, wherein c1 and c2 are both constants.

In the above embodiment, the first performance benefit indicator generated by the change in data width and/or data type of the value included in the target column after the target column is encoded based on the dictionary is determined. Specifically, the first performance benefit indicator is determined as follows:
a first average data width and a first data type of the value included in the target column are determined, and a second average data width and a second data type of the corresponding replacement value are determined;
a first target coefficient is determined based on the first data type and the second data type;
a product of a difference between the first average data width and the second average data width and the first target coefficient is obtained, and the first performance benefit indicator is determined based on the product.

The first data type and the second data type may include a variable-length data type or a fixed-length data type.

Exemplarily, assuming that the first average data width of the value included in the target column is B, for example, for the character data type char(30), B=30; the second average data width of the replacement value in the dictionary is A, for example, for the integer data type int32, A=4, the formula of the first performance benefit indicator corresponding to a single data record may be:
first performance benefit indicator=F*(B−A)
wherein F is the first target coefficient, and if the first data type is a variable-length data type and the second data type is a fixed-length data type, F>1; if both the first data type and the second data type are fixed-length data types or variable-length data types, F=1; and if the first data type is a fixed-length data type and the second data type is a variable-length data type, F<1.

In the above embodiment, the second performance benefit indicator generated in the database operation process in which the target column participates after the target column is encoded based on the dictionary is determined. Specifically, the second performance benefit indicator is determined as follows:
A first average data width and a first data type of the value included in the target column are determined, and a second average data width and a second data type of the corresponding replacement value are determined;
A first target coefficient is determined based on the first data type and the second data type;
An operation type and the number of records of the database operation process in which the target column participates after the target column is encoded based on the dictionary are determined; and a second target coefficient is determined based on the operation type.

A product of a difference between the first average data width and the second average data width, the first target coefficient, the second target coefficient, and the number of records is obtained, and the second performance benefit indicator is determined based on the product.

In this embodiment, because the performance benefit indicator is also related to the complexity of the operation type of the database operation process in which the target column participates, in order to consider the factor of the operation type, different second target coefficients are preset for operation types with different complexity degrees. In addition, the performance benefit indicator is also related to the number of records (i.e., the number of rows) participating in the database operation process. Therefore, the second performance benefit indicator may be obtained based on the product of the difference between the first average data width and the second average data width, the first target coefficient, the second target coefficient, and the number of records. The detailed formula may be:

ci*R*F*(B−A)
wherein ci is the second target coefficient corresponding to the operation type i. The operation type may include some complex operations such as join (connection), aggregate (aggregation), and shuffle (filtering), and the second target coefficients of different operation types are different; and R is the number of records (i.e., the number of rows) of the database operation process in which the target column participates.

Optionally, the second performance benefit indicator generated in the database operation process in which the target column participates after the target column is encoded based on the dictionary is determined as follows:

In response to the target column participating in a plurality of database operation processes after the target column is encoded based on the dictionary, the second performance benefit indicator generated in each database operation process is obtained respectively, and the obtained second performance benefit indicators are accumulated, to obtain the accumulated second performance benefit indicator.

Exemplarily, assuming that the first average data width is B, the second average data width is A, the first target coefficient is F, the second target coefficients of join, aggregate, and shuffle are c1, c2, and c3, respectively, the number of records participating in join in the target column is R1, the number of records participating in aggregate in the target column is R2, and the number of records participating in shuffle in the target column is R3, the second performance benefit indicator is: ci*R1*F*(B−A)+c2*R2*F*(B−A)+c3*R3*F*(B−A).

S302, whether the dictionary-based optimization is enabled is determined based on the predicted cost indicator.

In this embodiment, the predicted cost indicator represents whether the benefit brought by the dictionary is greater than the overhead introduced by the dictionary. If the performance overhead indicator in the predicted cost indicator is less than the performance benefit indicator, the dictionary-based optimization may be enabled. If the performance overhead indicator in the predicted cost indicator is greater than or equal to the performance benefit indicator, the dictionary-based optimization is not enabled.

In the database processing method provided in another embodiment of the present disclosure, the predicted cost indicator after the dictionary-based optimization is enabled for the target column associated with the operation instruction is determined, and whether the dictionary-based optimization is enabled is determined based on the predicted cost indicator. The predicted cost indicator is obtained by considering the performance overhead indicator and the performance benefit indicator of the target column after the dictionary-based optimization, and then the determination is performed based on the predicted cost indicator. The performance benefit and the overhead are comprehensively considered, so that the performance decline caused by the configuration of the dictionary is avoided, and whether to enable the dictionary-based optimization is automatically determined, thereby improving the database operation performance of the database. In addition, there is no need for user intervention, and no need for the user to provide and maintain the dictionary, thereby reducing the user costs.

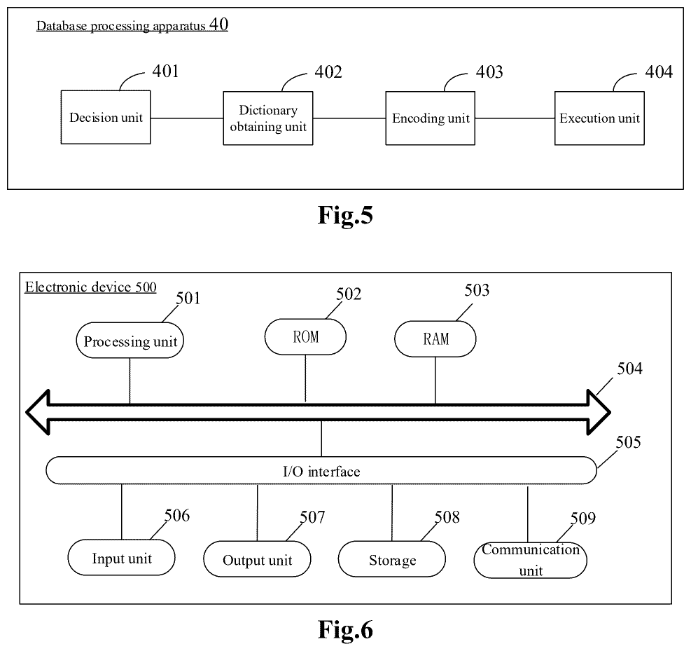

Corresponding to the database processing method in the above embodiments, FIG. 5 is a block diagram of a structure of a database processing apparatus according to an embodiment of the present disclosure. For ease of description, only parts related to the embodiments of the present disclosure are shown. Referring to FIG. 5, the database processing apparatus 40 includes a decision unit 401, a dictionary obtaining unit 402, an encoding unit 403, and an execution unit 404.

The decision unit 401 is configured to receive an operation instruction for a database, and determine whether dictionary-based optimization is enabled for a target column associated with the operation instruction;
the dictionary obtaining unit 402 is configured to: in response to determining that the dictionary-based optimization is enabled, obtain a dictionary corresponding to the target column, wherein the dictionary includes a mapping relationship between a value included in the target column and a corresponding replacement value;
the encoding unit 403 is configured to encode the target column based on the dictionary to replace the value included in the target column with the corresponding replacement value; and
the execution unit 404 is configured to: convert, based on the dictionary, the operation instruction into an operation instruction corresponding to the encoded target column, execute the converted operation instruction, and decode an operation result based on the dictionary.

In one or more embodiments of the present disclosure, the dictionary obtaining unit 402 is further configured to:
obtain a number of distinct values included in the target column of the database, and in response to the number of distinct values being less than a preset number threshold, obtain the distinct values included in the target column, and construct the dictionary based on the distinct values included in the target column; and/or
obtain the distinct values included in the target column based on an operator and/or a function included in a first execution plan corresponding to the operation instruction, and construct the dictionary based on some or all of the distinct values.

In one or more embodiments of the present disclosure, the dictionary obtaining unit 402 is further configured to:
generate a first execution plan based on the operation instruction, and determine an operator type included in the first execution plan;
in response to determining that the operator type includes a scan operator, obtain a number of distinct values included in the target column of the database, and in response to the number of distinct values being less than a preset number threshold, obtain the distinct values included in the target column, and construct a first dictionary based on the distinct values included in the target column; and/or
in response to determining that the operator type includes a filter operator or a join operator, obtain the distinct values included in the target column based on a predicate in the operator, and construct a second dictionary based on the distinct values included in the target column; and/or
in response to determining that the operator type includes a project operator, obtain the distinct values included in the target column based on a function in the operator, and construct a third dictionary based on the distinct values included in the target column.

In one or more embodiments of the present disclosure, the dictionary obtaining unit 402 is further configured to:
in response to the number of distinct values being less than the preset number threshold, send a second execution plan for querying the distinct values included in the target column to an execution engine of the database, and receive the distinct values included in the target column returned by the execution engine based on the second execution plan.

In one or more embodiments of the present disclosure, the dictionary obtaining unit 402 is further configured to:
determine whether the dictionary is stored in a cache;
in response to determining that the dictionary is not stored in the cache or the dictionary in the cache has expired, create the dictionary and store the dictionary in the cache; or
in response to determining that the dictionary is stored in the cache and the dictionary has not expired, obtain the dictionary from the cache.

In one or more embodiments of the present disclosure, the decision unit 401 is further configured to:
determine a predicted cost indicator after the dictionary-based optimization is enabled for the target column associated with the operation instruction, and determine whether the dictionary-based optimization is enabled based on the predicted cost indicator.

In one or more embodiments of the present disclosure, the decision unit 401 is further configured to:
determine a performance overhead indicator and a performance benefit indicator after the dictionary-based optimization is enabled for the target column associated with the operation instruction, and determine the predicted cost indicator based on the performance overhead indicator and the performance benefit indicator.

In one or more embodiments of the present disclosure, the decision unit 401 is further configured to:
determine a performance overhead indicator generated by encoding the target column based on the dictionary and decoding the operation result;
wherein determining the performance benefit indicator after the dictionary-based optimization is enabled for the target column associated with the operation instruction includes:
determining a first performance benefit indicator generated by a change in data width and/or data type of the value included in the target column after the target column is encoded based on the dictionary; and/or
determining a second performance benefit indicator generated in the database operation process in which the target column participates after the target column is encoded based on the dictionary.

In one or more embodiments of the present disclosure, the decision unit 401 is further configured to:
determine a first data amount for encoding the target column based on the dictionary and a second data amount decoding the operation result;
determine a first performance overhead of the encoding process by using a preset encoding complexity function based on the first data amount, and determine a second performance overhead of the decoding process by using a preset decoding complexity function based on the second data amount; and
determine a sum of the first performance overhead and the second performance overhead as the performance overhead indicator.

In one or more embodiments of the present disclosure, the decision unit 401 is further configured to:
determine a first average data width and a first data type of the value included in the target column, and determine a second average data width and a second data type of the corresponding replacement value;
determine a first target coefficient based on the first data type and the second data type; and
obtain a product of a difference between the first average data width and the second average data width and the first target coefficient, and determine the first performance benefit indicator based on the product.

In one or more embodiments of the present disclosure, the decision unit 401 is further configured to:
determine a first average data width and a first data type of the value included in the target column, and determine a second average data width and a second data type of the corresponding replacement value;
determine a first target coefficient based on the first data type and the second data type;
determine an operation type and the number of records of the database operation process in which the target column participates after the target column is encoded based on the dictionary; and determine a second target coefficient based on the operation type; and
obtain a product of a difference between the first average data width and the second average data width, the first target coefficient, the second target coefficient, and the number of records, and determine the second performance benefit indicator based on the product.

In one or more embodiments of the present disclosure, the decision unit 401 is further configured to:
in response to the target column participating in a plurality of database operation processes after the target column is encoded based on the dictionary, obtain the second performance benefit indicator generated in each database operation process respectively, and accumulate the obtained second performance benefit indicators, to obtain the accumulated second performance benefit indicator.

The apparatus provided in this embodiment may be used to implement the technical solutions of the above method embodiments, and the implementation principles and technical effects thereof are similar.

Details are not described herein again in this embodiment.

Referring to FIG. 6, FIG. 6 illustrates a schematic diagram of a structure of an electronic device 500 suitable for implementing the embodiments of the present disclosure. The electronic device 500 may be a terminal device or a server. The terminal device may include, but is not limited to, a mobile terminal such as a mobile phone, a laptop, a digital broadcast receiver, a personal digital assistant (abbreviated as PDA), a tablet computer, a portable media player (abbreviated as PMP), a vehicle-mounted terminal (such as a vehicle-mounted navigation terminal), and the like, as well as a fixed terminal such as a digital TV, a desktop computer, and the like. The electronic device shown in FIG. 6 is merely an example, and should not impose any limitation to the function and scope of use of the embodiments of the present disclosure.

As shown in FIG. 6, the electronic device 500 may include a processing unit (such as a central processing unit, a graphics processing unit, etc.) 501, which may perform various appropriate actions and processing according to a program stored in a read-only memory (abbreviated as ROM) 502 or a program loaded from a storage 508 to a random access memory (abbreviated as RAM) 503. The RAM 503 further stores various programs and data required for the operation of the electronic device 500. The processing unit 501, the ROM 502, and the RAM 503 are connected to each other through a bus 504. An input/output (I/O) interface 505 is also connected to the bus 504.

Generally, the following unit may be connected to the I/O interface 505: an input unit 506 including, for example, a touch screen, a touchpad, a keyboard, a mouse, a camera, a microphone, an accelerometer, a gyroscope, and the like; an output unit 507 including, for example, a liquid crystal display (abbreviated as LCD), a speaker, a vibrator, and the like; a storage 508 including, for example, a magnetic tape, a hard disk, and the like; and a communication unit 509. The communication unit 509 may allow the electronic device 500 to perform wireless or wired communication with other devices to exchange data. Although FIG. 6 shows the electronic device 500 having various unit, it should be understood that not all of the illustrated unit are required to be implemented or provided. More or fewer unit may alternatively be implemented or provided.

In particular, according to the embodiments of the present disclosure, the process described above with reference to the flowchart may be implemented as a computer software program. For example, an embodiment of the present disclosure includes a computer program product, which includes a computer program carried on a computer-readable medium, wherein the computer program includes program code for executing the method shown in the flowchart. In such an embodiment, the computer program may be downloaded and installed from a network through the communication unit 509, or may be installed from the storage 508, or may be installed from the ROM 502. When the computer program is executed by the processing unit 501, the above-mentioned functions defined in the method of the embodiments of the present disclosure are executed.

It should be noted that the computer-readable medium in the present disclosure may be a computer-readable signal medium or a computer-readable storage medium, or any combination thereof. The computer-readable storage medium may be, for example, but not limited to, an electrical, magnetic, optical, electromagnetic, infrared, or semiconductor system, apparatus, or device, or any combination thereof. More specific examples of the computer-readable storage medium may include, but are not limited to, an electrical connection with one or more wires, a portable computer magnetic disk, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination thereof. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as a part of a carrier, and computer-readable program code is carried in the data signal. The data signal propagated in this manner may be in various forms, including but not limited to an electromagnetic signal, an optical signal, or any suitable combination thereof. The computer-readable signal medium may also be any computer-readable medium other than the computer-readable storage medium, and the computer-readable signal medium may send, propagate, or transmit a program for use by or in combination with an instruction execution system, apparatus, or device. The program code contained on the computer-readable medium may be transmitted by using any suitable medium, including but not limited to an electric wire, an optical cable, RF (radio frequency), etc., or any suitable combination thereof.

The computer-readable medium may be contained in the electronic device, or may exist alone without being assembled into the electronic device.

The above computer-readable medium carries one or more programs, and when the one or more programs are executed by the electronic device, the electronic device is caused to execute the method shown in the above embodiments.

The computer program code for performing the operations of the present disclosure may be written in one or more programming languages or a combination thereof. The above programming languages include object-oriented programming languages such as Java, Smalltalk, C++, and also include conventional procedural programming languages such as the “C” programming language or similar programming languages. The program code may be executed entirely on a user's computer, partly on a user's computer, as a stand-alone software package, partly on a user's computer and partly on a remote computer, or entirely on a remote computer or server. In the scenario involving the remote computer, the remote computer may be connected to the user's computer through any type of network, including a local area network (abbreviated as LAN) or a wide area network (abbreviated as WAN), or the connection may be made to an external computer (for example, through the Internet using an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a special-purpose hardware-based system that performs the specified functions or operations, or may also be implemented by a combination of special-purpose hardware and computer instructions.

The units involved in the embodiments described in the present disclosure may be implemented by software or hardware. The name of a unit does not constitute a limitation on the unit itself under certain circumstances. For example, a first obtaining unit may also be described as “a unit for obtaining at least two internet protocol addresses”.

The functions described herein above may be performed, at least in part, by one or more hardware logic components. For example, without limitation, available exemplary types of hardware logic components include: a field programmable gate array (FPGA), an application specific integrated circuit (ASIC), an application specific standard product (ASSP), a system on a chip (SOC), a complex programmable logical device (CPLD), etc.

In the context of the present disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of the machine-readable storage medium include an electrical connection based on one or more wires, a portable computer disk, a hard disk, a random access memory (RAM), a read only memory (ROM), an erasable programmable read only memory (EPROM or flash memory), an optical fiber, a portable compact disc read-only memory (CD-ROM), an optical storage device, a magnetic storage device, or any suitable combination of the foregoing.

In a first aspect, one or more embodiments of the present disclosure provide a database processing method. The database processing method includes:
receiving an operation instruction for a database, and determining whether dictionary-based optimization is enabled for a target column associated with the operation instruction;
in response to determining that the dictionary-based optimization is enabled, obtaining a dictionary corresponding to the target column, wherein the dictionary includes a mapping relationship between a value included in the target column and a corresponding replacement value;
encoding the target column based on the dictionary to replace the value included in the target column with the corresponding replacement value;
converting, based on the dictionary, the operation instruction into an operation instruction corresponding to the encoded target column, executing the converted operation instruction, and decoding an operation result based on the dictionary.

According to one or more embodiments of the present disclosure, wherein obtaining the dictionary corresponding to the target column includes:
obtaining a number of distinct values included in the target column of the database, in response to the number of distinct values being less than a preset number threshold, obtaining the distinct values included in the target column, and constructing the dictionary based on the distinct values included in the target column; and/or
obtaining the distinct values included in the target column based on an operator and/or a function included in a first execution plan corresponding to the operation instruction, and constructing the dictionary based on some or all of the distinct values.

According to one or more embodiments of the present disclosure, wherein obtaining the dictionary corresponding to the target column includes:
generating a first execution plan based on the operation instruction, and determining an operator type included in the first execution plan;
in response to determining that the operator type includes a scan operator, obtaining a number of distinct values included in the target column of the database, and in response to the number of distinct values being less than a preset number threshold, obtaining the distinct values included in the target column, and constructing a first dictionary based on the distinct values included in the target column; and/or
in response to determining that the operator type includes a filter operator or a join operator, obtaining the distinct values included in the target column based on a predicate in the operator, and constructing a second dictionary based on the distinct values included in the target column; and/or
in response to determining that the operator type includes a project operator, obtaining the distinct values included in the target column based on a function in the operator, and constructing a third dictionary based on the distinct values included in the target column.

According to one or more embodiments of the present disclosure, wherein in response to the number of distinct values being less than the preset number threshold, obtaining the distinct values included in the target column includes:
in response to the number of distinct values being less than the preset number threshold, sending a second execution plan for querying the distinct values included in the target column to an execution engine of the database, and receiving the distinct values included in the target column returned by the execution engine based on the second execution plan.

According to one or more embodiments of the present disclosure, wherein obtaining the dictionary corresponding to the target column includes:
determining whether the dictionary is stored in a cache;
in response to determining that the dictionary is not stored in the cache or the dictionary in the cache has expired, creating the dictionary and storing the dictionary in the cache; or
in response to determining that the dictionary is stored in the cache and the dictionary has not expired, obtaining the dictionary from the cache.

According to one or more embodiments of the present disclosure, wherein determining whether the dictionary-based optimization is enabled for the target column associated with the operation instruction includes:
determining a predicted cost indicator after the dictionary-based optimization is enabled for the target column associated with the operation instruction, and determining whether the dictionary-based optimization is enabled based on the predicted cost indicator.

According to one or more embodiments of the present disclosure, wherein determining the predicted cost indicator after the dictionary-based optimization is enabled for the target column associated with the operation instruction includes:
determining a performance overhead indicator and a performance benefit indicator after the dictionary-based optimization is enabled for the target column associated with the operation instruction, and determining the predicted cost indicator based on the performance overhead indicator and the performance benefit indicator.

According to one or more embodiments of the present disclosure, wherein determining the performance overhead indicator after the dictionary-based optimization is enabled for the target column associated with the operation instruction includes:
determining a performance overhead indicator generated by encoding the target column based on the dictionary and decoding the operation result;
wherein determining the performance benefit indicator after the dictionary-based optimization is enabled for the target column associated with the operation instruction includes:
determining a first performance benefit indicator generated by a change in data width and/or data type of the value included in the target column after the target column is encoded based on the dictionary; and/or
determining a second performance benefit indicator generated in the database operation process in which the target column participates after the target column is encoded based on the dictionary.

According to one or more embodiments of the present disclosure, wherein determining the performance overhead indicator generated by encoding the target column based on the dictionary and decoding the operation result includes:
determining a first data amount for encoding the target column based on the dictionary and a second data amount for decoding the operation result;
determining a first performance overhead of an encoding process by using a preset encoding complexity function based on the first data amount, and determining a second performance overhead of a decoding process by using a preset decoding complexity function based on the second data amount;
determining a sum of the first performance overhead and the second performance overhead as the performance overhead indicator.

According to one or more embodiments of the present disclosure, wherein determining the first performance benefit indicator generated by the change in data width and/or data type of the value included in the target column after the target column is encoded based on the dictionary includes:
determining a first average data width and a first data type of the value included in the target column, and determining a second average data width and a second data type of the corresponding replacement value;
determining a first target coefficient based on the first data type and the second data type;
obtaining a product of a difference between the first average data width and the second average data width and the first target coefficient, and determining the first performance benefit indicator based on the product.

According to one or more embodiments of the present disclosure, wherein determining the second performance benefit indicator generated in the database operation process in which the target column participates after the target column is encoded based on the dictionary includes:
determining a first average data width and a first data type of the value included in the target column, and determining a second average data width and a second data type of the corresponding replacement value;
determining a first target coefficient based on the first data type and the second data type;
determining an operation type and a number of records of the database operation process in which the target column participates after the target column is encoded based on the dictionary, and determining a second target coefficient based on the operation type;
obtaining a product of a difference between the first average data width and the second average data width, the first target coefficient, the second target coefficient, and the number of records, and determining the second performance benefit indicator based on the product.

According to one or more embodiments of the present disclosure, wherein determining the second performance benefit indicator generated in the database operation process in which the target column participates after the target column is encoded based on the dictionary includes:
in response to the target column participating in a plurality of database operation processes after the target column is encoded based on the dictionary, separately obtaining the second performance benefit indicator generated in each database operation process, and accumulating obtained second performance benefit indicators, to obtain the accumulated second performance benefit indicator.

In a second aspect, one or more embodiments of the present disclosure provide a database processing apparatus. The database processing apparatus includes a decision unit, a dictionary obtaining unit, an encoding unit, and an execution unit.

The decision unit is configured to receive an operation instruction for a database, and determine whether dictionary-based optimization is enabled for a target column associated with the operation instruction.

The dictionary obtaining unit is configured to: in response to determining that the dictionary-based optimization is enabled, obtain a dictionary corresponding to the target column, wherein the dictionary includes a mapping relationship between a value included in the target column and a corresponding replacement value.

The encoding unit is configured to encode the target column based on the dictionary to replace the value included in the target column with the corresponding replacement value.

The execution unit is configured to: convert, based on the dictionary, the operation instruction into an operation instruction corresponding to the encoded target column, execute the converted operation instruction, and decode an operation result based on the dictionary.

According to one or more embodiments of the present disclosure, the dictionary obtaining unit is further configured to:
obtain a number of distinct values included in the target column of the database, and in response to the number of distinct values being less than a preset number threshold, obtain the distinct values included in the target column, and construct the dictionary based on the distinct values included in the target column; and/or
obtain the distinct values included in the target column based on an operator and/or a function included in a first execution plan corresponding to the operation instruction, and construct the dictionary based on some or all of the distinct values.

According to one or more embodiments of the present disclosure, the dictionary obtaining unit is further configured to:
generate the first execution plan based on the operation instruction, and determine an operator type included in the first execution plan;
in response to determining that the operator type includes a scan operator, obtain a number of distinct values included in the target column of the database, and in response to the number of distinct values being less than the preset number threshold, obtain the distinct values included in the target column, and construct a first dictionary based on the distinct values included in the target column; and/or
in response to determining that the operator type includes a filter operator or a join operator, obtain the distinct values included in the target column based on a predicate in the operator, and construct a second dictionary based on the distinct values included in the target column; and/or
in response to determining that the operator type includes a project operator, obtain the distinct values included in the target column based on a function in the operator, and construct a third dictionary based on the distinct values included in the target column.

According to one or more embodiments of the present disclosure, the dictionary obtaining unit is further configured to:
in response to the number of distinct values being less than the preset number threshold, send a second execution plan for querying the distinct values included in the target column to an execution engine of the database, and receive the distinct values included in the target column returned by the execution engine based on the second execution plan.

According to one or more embodiments of the present disclosure, the dictionary obtaining unit is further configured to:
determine whether the dictionary is stored in a cache;
in response to determining that the dictionary is not stored in the cache or the dictionary in the cache has expired, create the dictionary and store the dictionary in the cache; or
in response to determining that the dictionary is stored in the cache and the dictionary has not expired, obtain the dictionary from the cache.

According to one or more embodiments of the present disclosure, the decision unit is further configured to:
determine a predicted cost indicator after the dictionary-based optimization is enabled for the target column associated with the operation instruction, and determine whether the dictionary-based optimization is enabled based on the predicted cost indicator.

According to one or more embodiments of the present disclosure, the decision unit is further configured to:
determine a performance overhead indicator and a performance benefit indicator after the dictionary-based optimization is enabled for the target column associated with the operation instruction, and determine the predicted cost indicator based on the performance overhead indicator and the performance benefit indicator.

According to one or more embodiments of the present disclosure, the decision unit is further configured to:
determine a performance overhead indicator generated by encoding the target column based on the dictionary and decoding the operation result;
determining the performance benefit indicator after the dictionary-based optimization is enabled for the target column associated with the operation instruction includes:
determining a first performance benefit indicator generated by a change in data width and/or data type of the value included in the target column after the target column is encoded based on the dictionary; and/or
determining a second performance benefit indicator generated in the database operation process in which the target column participates after the target column is encoded based on the dictionary.

According to one or more embodiments of the present disclosure, the decision unit is further configured to:
determine a first data amount for encoding the target column based on the dictionary and a second data amount decoding the operation result;
determine a first performance overhead of the encoding process by using a preset encoding complexity function based on the first data amount, and determine a second performance overhead of the decoding process by using a preset decoding complexity function based on the second data amount; and
determine a sum of the first performance overhead and the second performance overhead as the performance overhead indicator.

According to one or more embodiments of the present disclosure, the decision unit is further configured to:
determine a first average data width and a first data type of the value included in the target column, and determine a second average data width and a second data type of the corresponding replacement value;
determine a first target coefficient based on the first data type and the second data type; and
obtain a product of a difference between the first average data width and the second average data width and the first target coefficient, and determine the first performance benefit indicator based on the product.

According to one or more embodiments of the present disclosure, the decision unit is further configured to:
determine a first average data width and a first data type of the value included in the target column, and determine a second average data width and a second data type of the corresponding replacement value;
determine a first target coefficient based on the first data type and the second data type;
determine an operation type and the number of records of the database operation process in which the target column participates after the target column is encoded based on the dictionary; and determine a second target coefficient based on the operation type; and
obtain a product of a difference between the first average data width and the second average data width, the first target coefficient, the second target coefficient, and the number of records, and determine the second performance benefit indicator based on the product.

According to one or more embodiments of the present disclosure, the decision unit is further configured to:
in response to the target column participating in a plurality of database operation processes after the target column is encoded based on the dictionary, separately obtain the second performance benefit indicator generated in each database operation process, and accumulate the obtained second performance benefit indicators, to obtain the accumulated second performance benefit indicator.

In a third aspect, one or more embodiments of the present disclosure provide an electronic device, including at least one processor and a memory.

The memory stores computer-executed instructions.

The at least one processor executes the computer-executed instructions stored in the memory, to cause the at least one processor to perform the database processing method according to the first aspect and various possible designs of the first aspect.

In a fourth aspect, one or more embodiments of the present disclosure provide a computer-readable storage medium. The computer-readable storage medium stores computer-executed instructions. When a processor executes the computer-executed instructions, the database processing method according to the first aspect and various possible designs of the first aspect is implemented.

In a fifth aspect, one or more embodiments of the present disclosure provide a computer program product. The computer program product includes computer-executed instructions. When a processor executes the computer-executed instructions, the database processing method according to the first aspect and various possible designs of the first aspect is implemented.

The above description is merely preferred embodiments of the present disclosure and an illustration of the applied technical principles. Those skilled in the art should understand that the scope of disclosure involved in the present disclosure is not limited to the technical solutions formed by the specific combination of the above technical features, and should also cover other technical solutions formed by any combination of the above technical features or equivalent features thereof without departing from the above disclosed concept, for example, a technical solution formed by replacing the above features with technical features with similar functions disclosed in the present disclosure (but not limited to).

In addition, although operations are depicted in a particular order, it should not be understood that these operations are required to be performed in the specific order shown or in a sequential order. Under certain circumstances, multitasking and parallel processing may be advantageous. Similarly, although the above discussion contains several specific implementation details, these should not be interpreted as limiting the scope of the present disclosure. Certain features that are described in the context of separate embodiments may also be implemented in combination in a single embodiment. Conversely, various features that are described in the context of a single embodiment may also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. Rather, the specific features and actions described above are merely exemplary forms of implementing the claims.

1. A database processing method, comprising:
receiving an operation instruction for a database, and determining whether dictionary-based optimization is enabled for a target column associated with the operation instruction;
in response to determining that the dictionary-based optimization is enabled, obtaining a dictionary corresponding to the target column, wherein the dictionary comprises a mapping relationship between a value comprised in the target column and a corresponding replacement value;
encoding the target column based on the dictionary to replace the value comprised in the target column with the corresponding replacement value; and
converting, based on the dictionary, the operation instruction into an operation instruction corresponding to the encoded target column, executing the converted operation instruction, and decoding an operation result based on the dictionary.

2. The method of claim 1, wherein obtaining the dictionary corresponding to the target column comprises:
obtaining a number of distinct values comprised in the target column of the database, in response to the number of distinct values being less than a preset number threshold, obtaining the distinct values comprised in the target column, and constructing the dictionary based on the distinct values comprised in the target column; and/or
obtaining the distinct values comprised in the target column based on an operator and/or a function comprised in a first execution plan corresponding to the operation instruction, and constructing the dictionary based on some or all of the distinct values.

3. The method of claim 1, wherein obtaining the dictionary corresponding to the target column comprises:
generating a first execution plan based on the operation instruction, and determining an operator type comprised in the first execution plan;
in response to determining that the operator type comprises a scan operator, obtaining a number of distinct values comprised in the target column of the database, and in response to the number of distinct values being less than a preset number threshold, obtaining the distinct values comprised in the target column, and constructing a first dictionary based on the distinct values comprised in the target column; and/or
in response to determining that the operator type comprises a filter operator or a join operator, obtaining the distinct values comprised in the target column based on a predicate in the operator, and constructing a second dictionary based on the distinct values comprised in the target column; and/or
in response to determining that the operator type comprises a project operator, obtaining the distinct values comprised in the target column based on a function in the operator, and constructing a third dictionary based on the distinct values comprised in the target column.

4. The method of claim 2, wherein in response to the number of distinct values being less than the preset number threshold, obtaining the distinct values comprised in the target column comprises:
in response to the number of distinct values being less than the preset number threshold, sending a second execution plan for querying the distinct values comprised in the target column to an execution engine of the database, and receiving the distinct values comprised in the target column returned by the execution engine based on the second execution plan.

5. The method of any of claim 1, wherein obtaining the dictionary corresponding to the target column comprises:
determining whether the dictionary is stored in a cache;
in response to determining that the dictionary is not stored in the cache or the dictionary in the cache has expired, creating the dictionary and storing the dictionary in the cache; or
in response to determining that the dictionary is stored in the cache and the dictionary has not expired, obtaining the dictionary from the cache.

6. The method of claim 1, wherein determining whether the dictionary-based optimization is enabled for the target column associated with the operation instruction comprises:
determining a predicted cost indicator after the dictionary-based optimization is enabled for the target column associated with the operation instruction, and determining whether the dictionary-based optimization is enabled based on the predicted cost indicator.

7. The method of claim 6, wherein determining the predicted cost indicator after the dictionary-based optimization is enabled for the target column associated with the operation instruction comprises:
determining a performance overhead indicator and a performance benefit indicator after the dictionary-based optimization is enabled for the target column associated with the operation instruction, and determining the predicted cost indicator based on the performance overhead indicator and the performance benefit indicator.

8. The method of claim 7, wherein determining the performance overhead indicator after the dictionary-based optimization is enabled for the target column associated with the operation instruction comprises:
determining a performance overhead indicator generated by encoding the target column based on the dictionary and decoding the operation result;
wherein determining the performance benefit indicator after the dictionary-based optimization is enabled for the target column associated with the operation instruction comprises:
determining a first performance benefit indicator generated by a change in data width and/or data type of the value comprised in the target column after the target column is encoded based on the dictionary; and/or
determining a second performance benefit indicator generated in the database operation process in which the target column participates after the target column is encoded based on the dictionary.

9. The method of claim 8, wherein determining the performance overhead indicator generated by encoding the target column based on the dictionary and decoding the operation result comprises:
determining a first data amount for encoding the target column based on the dictionary and a second data amount for decoding the operation result;
determining a first performance overhead of an encoding process by using a preset encoding complexity function based on the first data amount, and determining a second performance overhead of a decoding process by using a preset decoding complexity function based on the second data amount; and
determining a sum of the first performance overhead and the second performance overhead as the performance overhead indicator.

10. The method of claim 8, wherein determining the first performance benefit indicator generated by the change in data width and/or data type of the value comprised in the target column after the target column is encoded based on the dictionary comprises:
determining a first average data width and a first data type of the value comprised in the target column, and determining a second average data width and a second data type of the corresponding replacement value;
determining a first target coefficient based on the first data type and the second data type; and
obtaining a product of a difference between the first average data width and the second average data width and the first target coefficient, and determining the first performance benefit indicator based on the product.

11. The method of claim 8, wherein determining the second performance benefit indicator generated in the database operation process in which the target column participates after the target column is encoded based on the dictionary comprises:
determining a first average data width and a first data type of the value comprised in the target column, and determining a second average data width and a second data type of the corresponding replacement value;
determining a first target coefficient based on the first data type and the second data type;
determining an operation type and a number of records of the database operation process in which the target column participates after the target column is encoded based on the dictionary, and determining a second target coefficient based on the operation type; and
obtaining a product of a difference between the first average data width and the second average data width, the first target coefficient, the second target coefficient, and the number of records, and determining the second performance benefit indicator based on the product.

12. The method of claim 8, wherein determining the second performance benefit indicator generated in the database operation process in which the target column participates after the target column is encoded based on the dictionary comprises:
in response to the target column participating in a plurality of database operation processes after the target column is encoded based on the dictionary, separately obtaining the second performance benefit indicator generated in each database operation process, and accumulating obtained second performance benefit indicators, to obtain the accumulated second performance benefit indicator.

13. An electronic device, comprising at least one processor and a memory, wherein
the memory stores computer-executed instructions which, when executed by the at least one processor, cause the at least one processor:
receive an operation instruction for a database, and determine whether dictionary-based optimization is enabled for a target column associated with the operation instruction;
in response to determining that the dictionary-based optimization is enabled, obtain a dictionary corresponding to the target column, wherein the dictionary comprises a mapping relationship between a value comprised in the target column and a corresponding replacement value;
encode the target column based on the dictionary to replace the value comprised in the target column with the corresponding replacement value; and
convert, based on the dictionary, the operation instruction into an operation instruction corresponding to the encoded target column, execute the converted operation instruction, and decode an operation result based on the dictionary.

14. The electronic device of claim 13, wherein the computer-executed instructions that cause the processor to obtain the dictionary corresponding to the target column comprise instructions to cause the processor:
obtain a number of distinct values comprised in the target column of the database, in response to the number of distinct values being less than a preset number threshold, obtain the distinct values comprised in the target column, and construct the dictionary based on the distinct values comprised in the target column; and/or
obtain the distinct values comprised in the target column based on an operator and/or a function comprised in a first execution plan corresponding to the operation instruction, and construct the dictionary based on some or all of the distinct values.

15. The electronic device of claim 14, wherein the instructions that cause the processor, in response to the number of distinct values being less than the preset number threshold, to obtain the distinct values comprised in the target column comprise instructions to cause the processor:
in response to the number of distinct values being less than the preset number threshold, send a second execution plan for querying the distinct values comprised in the target column to an execution engine of the database, and receive the distinct values comprised in the target column returned by the execution engine based on the second execution plan.

16. The electronic device of claim 13, wherein the computer-executed instructions that cause the processor to determine whether the dictionary-based optimization is enabled for the target column associated with the operation instruction comprise instructions to cause the processor:
determine a predicted cost indicator after the dictionary-based optimization is enabled for the target column associated with the operation instruction, and determine whether the dictionary-based optimization is enabled based on the predicted cost indicator.

17. The electronic device of claim 16, wherein the instructions that cause the processor to determine the predicted cost indicator after the dictionary-based optimization is enabled for the target column associated with the operation instruction comprise instructions to cause the processor:
determine a performance overhead indicator and a performance benefit indicator after the dictionary-based optimization is enabled for the target column associated with the operation instruction, and determine the predicted cost indicator based on the performance overhead indicator and the performance benefit indicator.

18. The electronic device of claim 17, wherein the instructions that cause the processor to determine the performance overhead indicator after the dictionary-based optimization is enabled for the target column associated with the operation instruction comprise instructions to cause the processor:
determine a performance overhead indicator generated by encoding the target column based on the dictionary and decoding the operation result;
wherein the instructions that cause the processor to determine the performance benefit indicator after the dictionary-based optimization is enabled for the target column associated with the operation instruction comprise instructions to cause the processor:
determine a first performance benefit indicator generated by a change in data width and/or data type of the value comprised in the target column after the target column is encoded based on the dictionary; and/or
determine a second performance benefit indicator generated in the database operation process in which the target column participates after the target column is encoded based on the dictionary.

19. The electronic device of claim 18, wherein the instructions that cause the processor to determine the performance overhead indicator generated by encoding the target column based on the dictionary and decoding the operation result comprise instructions to cause the processor:
determine a first data amount for encoding the target column based on the dictionary and a second data amount for decoding the operation result;
determine a first performance overhead of an encoding process by using a preset encoding complexity function based on the first data amount, and determine a second performance overhead of a decoding process by using a preset decoding complexity function based on the second data amount; and
determine a sum of the first performance overhead and the second performance overhead as the performance overhead indicator.

20. A computer program product, being tangibly stored on a non-transitory computer readable medium and comprising computer-executed instructions, which, when executed by a processor, to cause the processor to perform:
receive an operation instruction for a database, and determine whether dictionary-based optimization is enabled for a target column associated with the operation instruction;
in response to determining that the dictionary-based optimization is enabled, obtain a dictionary corresponding to the target column, wherein the dictionary comprises a mapping relationship between a value comprised in the target column and a corresponding replacement value;
encode the target column based on the dictionary to replace the value comprised in the target column with the corresponding replacement value; and
convert, based on the dictionary, the operation instruction into an operation instruction corresponding to the encoded target column, execute the converted operation instruction, and decode an operation result based on the dictionary.
